(19) United States
(12) Patent Application Publication
(10) Pub. No.: US 2026/0299331 A1
(43) Pub. Date: Oct. 1, 2026

(54) PHOTONIC INTEGRATED CIRCUITS WITH EXTERNALLY MODULATED EMITTERS

(71) Applicants: Amr Helmy, Thornhill (CA); Jy Bhardwaj, Saratoga, CA (US)

(72) Inventors: Amr Helmy, Thornhill (CA); Jy Bhardwaj, Saratoga, CA (US)

(21) Appl. No.: 19/633,089

(22) Filed: Mar. 30, 2026

Related U.S. Application Data
(60) Provisional application No. 63/780,405, filed on Mar. 30, 2025.

(51) Int. Cl. G02F 1/035

(52) U.S. Cl. CPC G02F 1/035; G02F 2202/20

(57) ABSTRACT

An integrated photonics circuit includes a broadband emitter, an optical coupling device, and a planar guided wave modulator coupled to the optical coupling device. The optical coupling device is configured to receive broadband light emitted by the broadband emitter toward a first surface of the integrated photonics circuit, and the planar guided wave modulator is configured to externally modulate the received broadband light. The broadband emitter emits broadband light orthogonal to the planar guided wave modulator and is optically coupled to the optical coupling device without an optical fiber. In some embodiments, the planar guided wave modulator comprises an electro-optical coupled hybrid plasmonic waveguide (CHPW) configured to modulate broadband emitter output through an electro-optic effect applied across an electro-optical material layer thereof. In some embodiments, a first integrated circuit and a second integrated circuit are coupled in a stacked arrangement enabling high-density optical interconnects at terabit-class data rates.

### CROSS-REFERENCE TO RELATED APPLICATIONS

This application claims priority to and the benefits of U.S. Provisional Patent Application Ser. No. 63/780,405, filed on Mar. 30, 2025. The subject matter of this earlier filed application is hereby incorporated by reference.

### TECHNICAL FIELD

The systems and methods disclosed herein are directed to devices, systems, and methods for externally modulating light provided by an emitter or by an array of emitters.

### BACKGROUND

A photonic integrated circuit (PIC) includes photonic components that can be used to facilitate data communications and signal processing, among other applications. Unlike conventional electronic integrated circuits, which manipulate electrical signals, PICs operate by generating, transmitting, and processing light signals within one or more optical chips. PICs can enable higher bandwidth, reduced energy consumption, and increased integration density relative to purely electronic interconnect approaches. This makes PICs well-suited for modern telecommunication networks, data centers, and emerging quantum computing applications. The continued scaling of computing architectures toward chiplet-based designs, for example in which discrete functional dies are assembled in close proximity or in stacked configurations, has placed increasing demands on the bandwidth, density, and energy efficiency of chip-to-chip and chiplet-to-chiplet interconnects. Optical interconnects based on PICs have emerged as a promising approach to meeting these demands, particularly as electrical interconnect bandwidth reaches practical limits imposed by signal attenuation, crosstalk, and power dissipation.

### SUMMARY

Some conventional PICs generate optical data streams by modulating the light source, or emitter, directly. In such systems, the emitter is switched on and off, or otherwise driven, to encode data onto the optical output. The achievable modulation speed in such systems is constrained by the physical characteristics of the emitter. For example, the modulation of a micro-light emitting diode (micro-LED) emitter may be limited to on the order of several to tens of gigabits per second (Gbps). This ceiling reflects the relatively long carrier recombination lifetime inherent to LED-type devices. Achieving data transmission rates significantly greater than this ceiling using direct emitter modulation may require spatial or wavelength-division multiplexing schemes employing large numbers of emitters operating in parallel, increasing system complexity, physical footprint, and power consumption. As a practical matter, terabit-class data rates are generally not attainable through direct modulation of a single emitter.

Photonics systems may include optical fibers to transport light from an emitter to a PIC and to couple optical signals to downstream components. Vertical-emission micro-emitter arrays, such as arrays of micro-LEDs or vertical-cavity surface-emitting lasers (VCSELs), may be integrated into photonics systems using vertical fiber coupling directly to the array surface. This approach can impose packaging constraints, particularly in the vertical axis. Moreover, when multiplexing with multiple emitters is required to achieve adequate aggregate data rates, a correspondingly large number of optical fiber interconnects may be needed, e.g., on the order of hundreds of fibers per assembly, increasing physical volume, alignment complexity, and optical coupling losses at each interface. The fiber burden thus compounds as the emitter count grows, tightening packaging constraints as integration density demands increase.

Narrowband emitters, such as laser diodes and VCSELs, exhibit several characteristics that impose constraints in integrated photonic systems. Their emission wavelength is sensitive to temperature, requiring active thermal management and precise wavelength matching between the emitter and any downstream modulator or filter, which adds control complexity and power overhead. Narrowband coherent sources are also susceptible to optical feedback and back reflections, which can destabilize the output and introduce noise. This is typically mitigated by incorporating optical isolators, which incur insertion loss, cost, and additional physical volume. When conventional external modulators are used in combination with narrowband laser sources, they can introduce chirp, nonlinear transfer characteristics, and signal distortion that degrade signal fidelity, effects that are particularly pronounced in long-reach and coherent communication systems.

Broadband emitters, such as micro-LEDs and superluminescent diodes (SLDs), can improve upon these characteristics, offering greater thermal stability without temperature-dependent wavelength drift, and with lower per-device power consumption, longer operational lifetimes, and inherent insensitivity to optical feedback that eliminates the need for isolators. For example, the SLD combines the high spatial coherence and brightness of a laser with the broad spectral bandwidth of an LED, providing greater output power and improved beam collimation than a conventional LED, while maintaining the spectral breadth required for broadband external modulation. However, external modulation of broadband emitter output has historically presented a technical challenge: conventional external modulators used in silicon photonics, including carrier depletion modulators and thermally-tuned ring resonators, are optimized for narrowband, spectrally coherent input, and exhibit sharply reduced modulation efficiency when presented with broadband illumination spanning tens of nanometers in spectral width. The performance advantages of broadband emitters are thus largely unrealized within externally modulated PIC architectures. A further challenge in externally modulating broadband light is that the modulator simultaneously handles many optical wavelengths, which can result in wavelength-averaged modulation and a reduction in extinction ratio and signal-to-noise ratio relative to single-wavelength operation. The architectures described herein are configured to operate across the full spectral bandwidth of the broadband emitter, mitigating this effect through its broadband spectral tolerance.

Embodiments of the present disclosure address the foregoing by providing integrated photonics circuit architectures that decouple modulation from the emitter by routing emitter output through an external planar guided wave modulator. Accordingly, embodiments described herein enable data rates that are independent of emitter modulation bandwidth, supporting a wide range of optical communication applications from chip-scale interconnects to high-speed telecommunications links. In some embodiments of the present disclosure, one or more emitters are optically coupled to corresponding optical coupling devices without an optical fiber, thereby eliminating fiber-based interconnects and substantially improving packaging flexibility. In other embodiments, one or more emitters may be optically coupled to corresponding optical coupling devices via optical fiber, as further described herein. The embodiments of the present disclosure additionally provide a modulator architecture based on an electro-optical coupled hybrid plasmonic waveguide (CHPW) that is capable of efficiently handling broadband emitter output, making the practical benefits of broadband emitters fully realizable in externally modulated PIC architectures. These architectures are compatible with a range of integration approaches, including stacked chip-to-chip and chiplet-to-chiplet configurations, flip-chip bonding, thermo-compressive hybrid bonding, transfer-printing, and monolithic integration.

In accordance with a first embodiment of this disclosure, an integrated photonics circuit includes an optical coupling device configured to receive light incident upon a first surface of the optical coupling device, and a planar guided wave modulator coupled to the optical coupling device and configured to receive and externally modulate light from the optical coupling device. The integrated photonics circuit also includes a broadband emitter configured to emit broadband light having a radiation pattern that includes a direction orthogonal to the planar guided wave modulator toward the first surface of the optical coupling device. The optical coupling device is configured to receive at least a portion of the broadband light emitted by the broadband emitter.

In an implementation of the first embodiment, the broadband emitter faces the first surface of the optical coupling device and is configured to emit the broadband light vertically toward the optical coupling device.

In an implementation of the first embodiment, the broadband emitter is optically coupled to the optical coupling device without an optical fiber.

In an implementation of the first embodiment, the broadband emitter comprises a light-emitting diode (LED), a micro-LED, or an SLD.

In an implementation of the first embodiment, the broadband light emitted by the broadband emitter has a full-width half-maximum (FWHM) spectral width of at least ten nanometers (nm).

In an implementation of the first embodiment, the broadband light is produced by a combination of a plurality of narrowband emitters whose combined spectral output spans a broadband spectral range.

In an implementation of the first embodiment, the broadband emitter is configured to operate in a continuous wave manner, and the planar guided wave modulator is configured to externally modulate the broadband light to generate a modulated optical data stream.

In an implementation of the first embodiment, the integrated photonic circuit further comprises an in-plane optical waveguide coupled to the planar guided wave modulator. The optical coupling device comprises a grating coupler configured to receive light incident orthogonally to the planar guided wave modulator and to redirect the received light into the in-plane optical waveguide.

In an implementation of the first embodiment, the planar guided wave modulator comprises an electro-optical CHPW, the CHPW comprising an electro-optical material layer configured to modulate light in coupled plasmonic modes therein, a first semiconductor layer adjacent to a first surface of the electro-optical material layer, and a metal layer adjacent to a second surface of the electro-optical material layer, wherein the electro-optical material layer is configured to modulate the broadband light in the coupled plasmonic modes based on a voltage applied across a thickness of the electro-optical material layer.

In an implementation of the first embodiment, the electro-optical material layer comprises lithium niobate (LiNbO3), and at least one of the first semiconductor layer and a second semiconductor layer of the CHPW comprises silicon (Si) or doped silicon oxide (SiO2).

In accordance with a second embodiment of this disclosure, an integrated photonics circuit includes a first integrated circuit and a second integrated circuit. The first integrated circuit includes one or more optical coupling devices configured to receive light incident upon a first surface of the first integrated circuit, and one or more planar guided wave modulators, each coupled to a corresponding one of the array of optical coupling devices and configured to receive and externally modulate light from the corresponding optical coupling device. The second integrated circuit includes one or more emitters configured to emit light toward the first surface of the first integrated circuit, wherein the light has a radiation pattern that includes a direction orthogonal to the one or more planar guided wave modulators, and wherein the first integrated circuit is coupled to the second integrated circuit in a stacked, chip-to-chip manner.

In an implementation of the second embodiment, the one or more emitters comprise one or more VCSELs

In an implementation of the second embodiment, the one or more emitters and the one or more optical coupling devices are in a 1:1 correspondence such that each optical coupling device is configured to receive at least a portion of light emitted by a corresponding emitter.

In an implementation of the second embodiment, each emitter is optically coupled to a corresponding optical coupling device without an optical fiber.

In an implementation of the second embodiment, the first integrated circuit is flip-chipped onto the second integrated circuit, or the second integrated circuit is flip-chipped onto the first integrated circuit.

In an implementation of the second embodiment, the first integrated circuit and the second integrated circuit are coupled using thermo-compressive hybrid bonding, including die-to-wafer bonding or wafer-to-wafer bonding, based on dielectric-to-dielectric and metal-to-metal pad direct bonding.

In an implementation of the second embodiment, the first integrated circuit is coupled to the second integrated circuit using pick-and-place tools, micro-transfer printing, or other transfer-printing methods, or the second integrated circuit is coupled to the first integrated circuit using pick-and-place tools, micro-transfer printing, or other transfer-printing methods.

In an implementation of the second embodiment, the second integrated circuit comprises an array of emitters, where a first one of the array of emitters is configured to emit light having a first wavelength, a second one of the array of emitters is configured to emit light having a second wavelength different from the first wavelength, and the integrated photonics circuit is configured to implement a wavelength-division multiplexing (WDM) scheme using the first and second emitters.

In accordance with a third embodiment of this disclosure, a method of externally modulating broadband light in an integrated photonics circuit includes emitting, by a broadband emitter, broadband light having a radiation pattern that includes a direction orthogonal to a planar guided wave modulator toward a first surface of a first integrated circuit; receiving, by an optical coupling device coupled to the planar guided wave modulator on the first surface of the first integrated circuit, at least a portion of the broadband light from the broadband emitter without optical fiber coupling; and modulating, by the planar guided wave modulator, the broadband light to produce a modulated optical data stream.

In an implementation of the third embodiment, the modulating comprises applying a voltage across an electro-optical material layer of a CHPW to create coupled plasmonic modes within the electro-optical material layer, thereby modulating the broadband light via an electro-optic effect that changes a refractive index of the electro-optical material layer in proportion to the applied voltage.

In accordance with an embodiment of this disclosure, a thickness of the electro-optical material layer is less than a width of the electro-optical CHPW.

In accordance with an embodiment of this disclosure, a thickness of the metal layer is less than a width of the electro-optical CHPW.

In accordance with an embodiment of this disclosure, the integrated photonics circuit may be incorporated into a transceiver device. A transceiver is an opto-electronic component that combines optical transmitter and receiver functionality in a single integrated unit, enabling bidirectional communication over an optical link. In a transmitter role, the transceiver generates a modulated optical data stream from an electrical input signal and launches it onto an optical fiber or waveguide. In a receiver role, the transceiver detects an incoming optical signal and converts it back to an electrical signal for downstream processing. Transceivers are fundamental building blocks in high-speed data communications infrastructure, including data center interconnects, telecommunications networks, and chip-to-chip optical links. Transceivers typically rely on narrowband laser sources and narrowband modulators, which impose constraints on thermal stability, power consumption, and scalability. Incorporating a broadband emitter and an electro-optical CHPW as the planar guided wave modulator into a transceiver addresses these constraints by enabling thermally stable, low-power broadband optical transmission. In the transceiver device described herein, the electro-optical CHPW serves as the transmitter modulator, receiving continuous wave broadband light from the broadband emitter via the optical coupling device and modulating it to produce a modulated optical data stream. One or more photodetectors may be included to handle the receiver function, and a control circuit may be coupled to the electro-optical CHPW to adjust the modulation voltage and control the operation of the light source and photodetectors. In the transceiver embodiments described herein, the planar guided wave modulator, specifically the electro-optical CHPW, is a broadband-capable modulator configured to receive and modulate broadband light, distinguishing these embodiments from conventional transceivers that rely on narrowband modulators optimized for spectrally coherent input. The following embodiments describe various configurations of such a transceiver device.

In accordance with an embodiment of this disclosure, the transceiver device further comprises a light source optically coupled to the electro-optical CHPW, wherein the electro-optical CHPW is a transmitter modulator.

In accordance with an embodiment of this disclosure, the transceiver device further comprises a photodetector.

In accordance with an embodiment of this disclosure, the transceiver device further comprises a control circuit coupled to the electro-optical CHPW, wherein the control circuit is configured to control a voltage applied across a thickness of the electro-optical material layer.

In accordance with an embodiment of this disclosure, the transceiver device further comprises a plurality of photodetectors, wherein the electro-optical CHPW is optically coupled to one or more optical paths of the photodetectors.

In accordance with an embodiment of this disclosure, the transceiver device further comprises a plurality of waveguides or optical fibers coupled to the electro-optical CHPW and respectively to the photodetectors.

In accordance with an embodiment of this disclosure, the transceiver device further comprises a plurality of light sources, wherein the electro-optical CHPW is optically coupled to one or more optical paths of the light sources.

In accordance with an embodiment of this disclosure, the transceiver device further comprises a plurality of waveguides or optical fibers coupled to the electro-optical CHPW and respectively to the light sources.

In accordance with an embodiment of this disclosure, the transceiver device further comprises a plurality of photodetectors and respective light sources, wherein the electro-optical CHPW is optically coupled to one or more optical paths of the photodetectors and the light sources.

In accordance with an embodiment of this disclosure, the transceiver device further comprises a plurality of waveguides or optical fibers coupled to the electro-optical CHPW and respectively to the photodetectors and respective light sources.

In accordance with an embodiment of this disclosure, the transceiver device further comprises a plurality of optical coupling devices, wherein each of the plurality of optical coupling devices is configured to receive light from a corresponding emitter and to direct the received light to a corresponding planar guided wave modulator via a corresponding in-plane optical waveguide.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1 is a block diagram of an integrated photonics circuit in accordance with an embodiment of the present disclosure.

FIG. 2 is a perspective view of an integrated photonics circuit comprising an array of emitters and a corresponding array of optical coupling devices in accordance with an embodiment of the present disclosure.

FIG. 3 is a perspective view of an integrated photonics circuit comprising a first integrated circuit and a second integrated circuit coupled in a stacked, chip-to-chip arrangement in accordance with an embodiment of the present disclosure.

FIG. 4 is a side view of a portion of an integrated photonics circuit illustrating a flip-chip bonding arrangement in accordance with an embodiment of the present disclosure.

FIG. 5 is a cross-sectional view of an electro-optical CHPW as a planar guided wave modulator in accordance with an embodiment of the present disclosure.

FIG. 6 is a flowchart of a method of externally modulating broadband light in an integrated photonics circuit in accordance with an embodiment of the present disclosure.

### DETAILED DESCRIPTION

It should be understood at the outset that, although an illustrative implementation of one or more embodiments are provided below, the disclosed systems, apparatuses and/or methods may be implemented using any number of techniques, whether currently known or in existence. The present disclosure should in no way be limited to the illustrative implementations, drawings, and techniques illustrated below, including the exemplary designs and implementations illustrated and described herein, but may be modified within the scope of the appended claims along with their full scope of equivalents.

In some embodiments described herein, one or more broadband emitters are optically coupled to one or more planar guided wave modulators through corresponding optical coupling devices without the use of optical fiber interconnects. In these embodiments, the emitter or emitters are not modulated to generate the optical data stream. Instead, the optical coupling device receives light emitted by the broadband emitter and routes it, via an in-plane optical waveguide, to a planar guided wave modulator that externally modulates the received light. This approach decouples the modulation function from the emitter, enabling data rates that are independent of the physical modulation bandwidth of the emitter and that scale with the capabilities of the planar guided wave modulator. Such data rates are suitable for a wide range of applications, including high-speed optical interconnects in data centers, chip-to-chip and chiplet-to-chiplet communication links, telecommunications networks, and other applications in which the modulation bandwidth of the emitter would otherwise be a limiting factor. The emitter or array of emitters is positioned such that the emitted light has a radiation pattern that includes a direction orthogonal to the planar guided wave modulator, allowing the emitter to be coupled to the optical coupling device without an intervening optical fiber and substantially improving packaging flexibility in the vertical axis.

Operating the broadband emitter in a continuous wave manner also enables a fundamental improvement in optical output power relative to direct modulation approaches. In direct modulation, the emitter must switch at the full modulation rate, which constrains the drive current waveform and limits the achievable time-averaged optical output power. In the architectures described herein, the emitter operates continuously at its full drive current, delivering maximum optical power into the optical path, while all modulation is performed externally by the planar guided wave modulator. This separation of the power function from the modulation function results in higher optical power launched into the link, improving the optical link budget and enabling greater reach or improved signal margin at the receiver compared to direct modulation approaches at equivalent emitter drive conditions.

In other embodiments, one or more broadband emitters may be located remotely and optically coupled to one or more planar guided wave modulators through corresponding optical coupling devices via one or more optical fibers. In these fiber-coupled embodiments, the optical fiber or fibers carry the broadband light from the remote broadband emitter or emitters to the corresponding optical coupling device or devices on the first integrated circuit, which then redirect the received broadband light into the respective in-plane optical waveguides and planar guided wave modulators. As in the no-fiber embodiments, the modulation function remains external to the emitter, and the planar guided wave modulator externally modulates the received broadband light to produce a modulated optical data stream. Both the fiber-coupled and fiber-free embodiments are within the scope of the present disclosure, and the architectures described herein with reference to the figures may be implemented using either coupling approach unless otherwise specified.

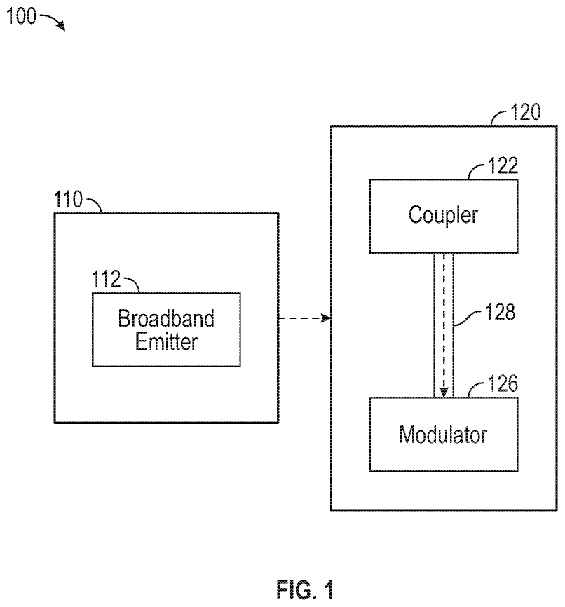

FIG. 1 is a block diagram of an integrated photonics circuit 100 in accordance with embodiments of the present disclosure. The integrated photonics circuit 100 includes a first component 110 of the integrated photonics circuit 100 and a second component 120 of the integrated photonics circuit 100. In an embodiment, the first component 110 is a first integrated circuit, also referred to herein as Chip 1, that includes a broadband emitter 112. The broadband emitter 112 is configured to emit broadband light toward the second component 120. The second component 120 is a second integrated circuit, also referred to herein as Chip 2, that includes an optical coupling device 122, an in-plane optical waveguide 128, and a planar guided wave modulator 126. As shown in FIG. 1, the broadband emitter 112 is optically coupled to the optical coupling device 122 via a dashed-line light path, which illustrates that the coupling between the broadband emitter 112 and the optical coupling device 122 occurs without an intervening optical fiber. The optical coupling device 122 receives at least a portion of the broadband light emitted by the broadband emitter 112 and redirects it into the in-plane optical waveguide 128. The in-plane optical waveguide 128 routes the received light to the planar guided wave modulator 126, which externally modulates the light to produce a modulated optical data stream. In embodiments of FIG. 1, the broadband emitter 112 is positioned such that its emitted light has a radiation pattern that includes a direction orthogonal to the planar guided wave modulator 126, enabling the broadband emitter 112 to be coupled to the optical coupling device 122 without an optical fiber.

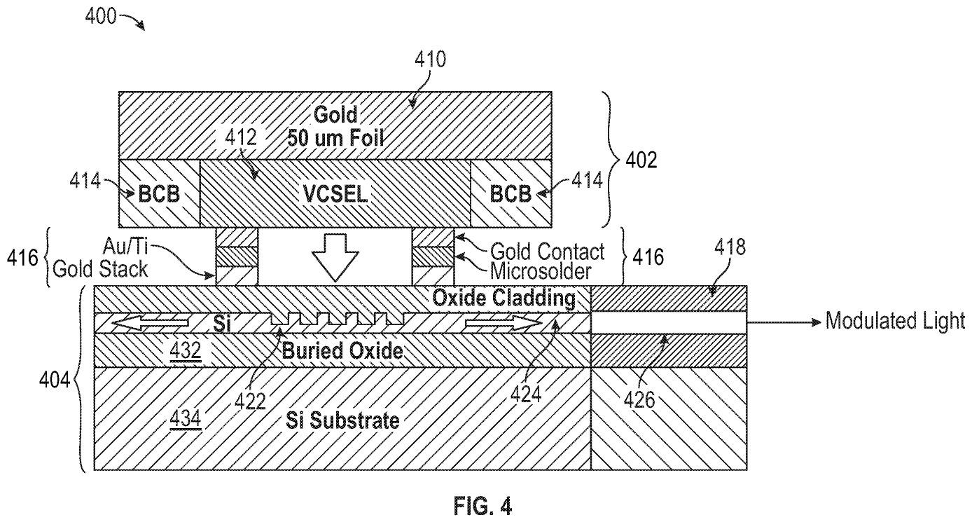

In some embodiments, the first component 110, Chip 1, and the second component 120, Chip 2, may be coupled together in a stacked, chip-to-chip or chiplet-to-chiplet arrangement using any of several integration approaches. For example, the first component 110, Chip 1, may be flip-chipped onto the second component 120, Chip 2. In another example, the second component 120, Chip 2, may be flip-chipped onto the first component 110, Chip 1, as further described below with reference to FIG. 4. In other embodiments, the first component 110, Chip 1, and the second component 120, Chip 2, may be coupled using thermo-compressive hybrid bonding, including die-to-wafer or wafer-to-wafer bonding based on dielectric-to-dielectric and metal-to-metal pad direct bonding. Alternatively, one or both of the first component 110, Chip 1, and the second component 120, Chip 2, may be positioned onto the other using pick-and-place tools, micro-transfer printing, or other transfer-printing methods. Regardless of the integration approach, the broadband emitter 112 on the first component 110, Chip 1, is positioned to face the first surface of the second component 120, Chip 2, such that the emitted broadband light travels toward the optical coupling device 122 without an optical fiber.

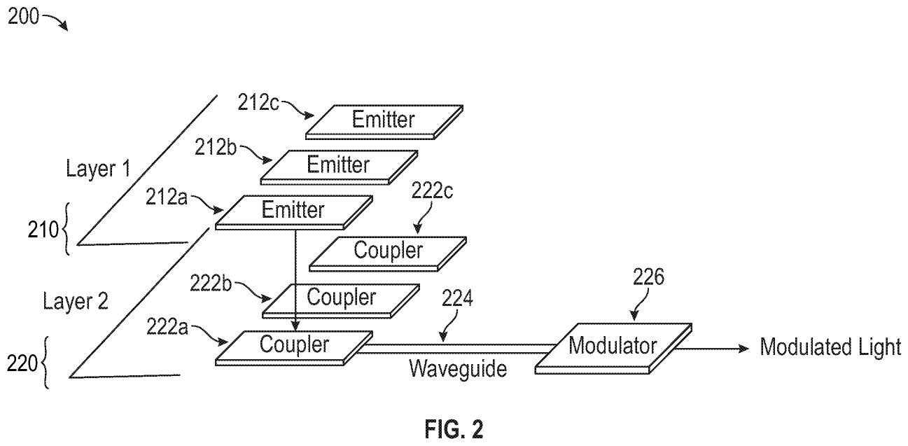

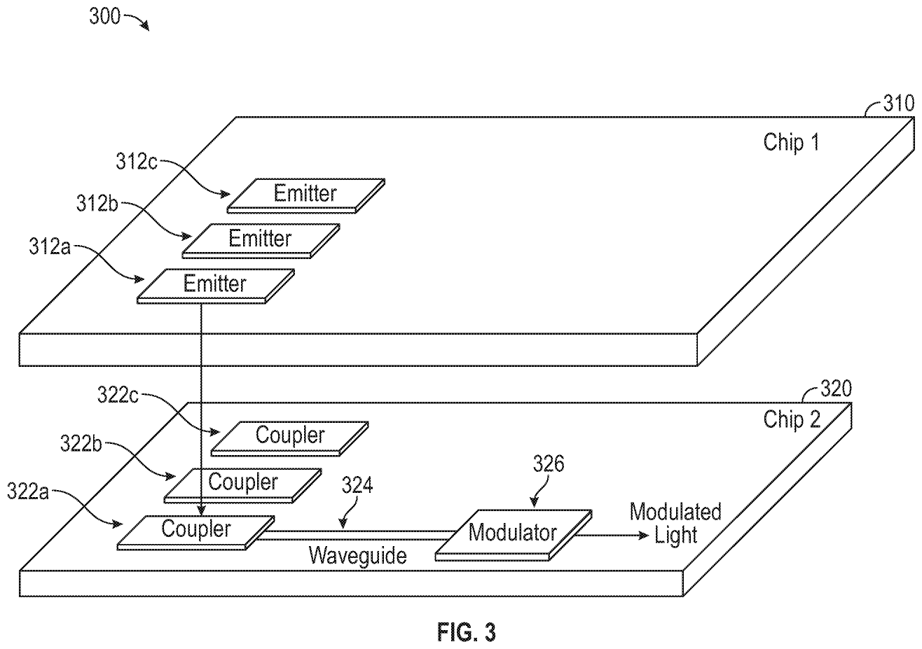

In another embodiment, the first component 110 is a first layer of the integrated photonics circuit 100 that includes a broadband emitter 112, and the second component 120 is a second layer of the integrated photonics circuit 100 that includes the optical coupling device 122, the in-plane optical waveguide 128, and the planar guided wave modulator 126. In this embodiment, the first layer 110 and the second layer 120 may be formed on a common substrate as part of a monolithic integration process, in which the emitter layer and the photonics layer are fabricated using compatible or sequential semiconductor processing steps. Alternatively, the first layer 110 and the second layer 120 may represent distinct heterogeneous process layers bonded together through wafer-level bonding techniques, such as thermo-compressive hybrid bonding or dielectric fusion bonding, allowing the emitter material system and the silicon photonics platform to be optimized independently before integration. In either case, the broadband emitter 112 in the first layer 110 is disposed above and aligned with the optical coupling device 122 in the second layer 120 such that the emitted broadband light is directed orthogonally toward the optical coupling device 122 without an optical fiber. Although FIG. 1 illustrates a single broadband emitter 112 and a single optical coupling device 122 for clarity, the integrated photonics circuit 100 may include an array of broadband emitters and corresponding optical coupling devices and planar guided wave modulators, as further described below with reference to FIG. 2 and FIG. 3.

FIG. 1 illustrates the fiber-free embodiment in which the broadband emitter 112 is positioned directly above the optical coupling device 122, providing advantages in packaging flexibility, reduced alignment sensitivity, and elimination of fiber interconnect components. As described above, in other embodiments the broadband emitter may be located on a remote chip or substrate and optically coupled to the optical coupling device via an optical fiber, in which case the optical coupling device receives the broadband light from the fiber and redirects it into the in-plane optical waveguide and planar guided wave modulator as described herein. Both the fiber-free and fiber-coupled configurations are within the scope of the present disclosure, and the integrated photonics circuit 100 of FIG. 1 may be implemented using either approach.

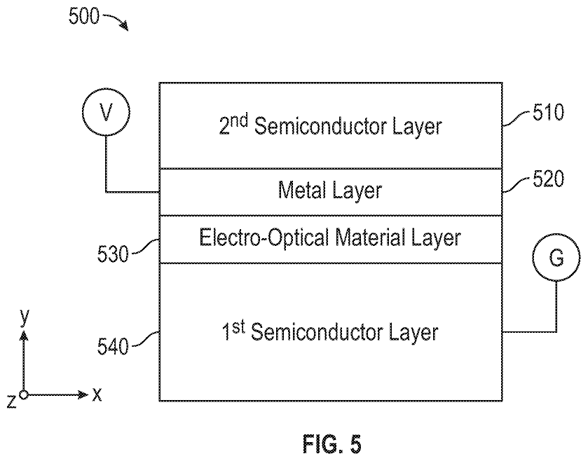

In an embodiment of the integrated photonics circuit 100 of FIG. 1, the broadband emitter 112 is a broadband light source, such as a micro-LED or an array of narrowband emitters whose combined spectral output spans a broadband spectral range, and the planar guided wave modulator 126 is implemented as an electro-optical CHPW. Unlike conventional external modulators such as carrier-depletion modulators or thermally-tuned ring resonators, which are optimized for narrowband, spectrally coherent input, the CHPW exhibits broadband spectral tolerance, enabling it to efficiently modulate light spanning tens of nanometers in spectral width. In this embodiment, the optical coupling device 122 receives the broadband light emitted by the broadband emitter 112 and redirects it into the in-plane optical waveguide 128, which routes the received broadband light to the CHPW modulator 126 for external modulation. The structure and operation of the CHPW are described in further detail below with reference to FIG. 5.

In some embodiments, the broadband emitter 112 may be located remotely from the second component 120, Chip 2, and the broadband light may be delivered to the optical coupling device 122 via an optical fiber rather than by direct orthogonal coupling. In such a fiber-coupled embodiment, the optical fiber carries the broadband light from the remote broadband emitter 112 to the optical coupling device 122 on Chip 2 (120), which then redirects the received broadband light into the in-plane optical waveguide 128 and the planar guided wave modulator 126 as described above. The CHPW modulates the received broadband light in the same manner regardless of whether the light arrives via direct orthogonal coupling or via optical fiber, since the CHPW operates on the guided broadband light within the in-plane optical path of Chip 2 (120) and is not sensitive to the upstream coupling mechanism. The fiber-coupled embodiment may be appropriate in applications where physical separation between the emitter and the photonic integrated circuit is desired or required, such as in data center rack-to-rack links or telecommunications systems, as further described below.

FIG. 2 is a perspective view of an integrated photonics circuit 200 in accordance with an embodiment of the present disclosure. The integrated photonics circuit 200 includes a first layer 210, referred to herein as Layer 1, and a second layer 220, referred to herein as Layer 2. As depicted in FIG. 2, Layer 1 (210) includes an array of emitters, depicted as emitters 212a, 212b, and 212c, and collectively referred to as emitters 212. The array of emitters 212 may be of varying dimensions and/or bandwidth capabilities for emitted light. Layer 2 (220) includes a corresponding array of optical coupling devices, depicted as optical coupling devices 222a, 222b, and 222c, and collectively referred to as optical coupling devices 222. The one or more optical coupling devices 222 and the one or more emitters 212 may be in a 1:1 correspondence such that each optical coupling device 222 is configured to receive at least a portion of light emitted by a corresponding emitter 212. Although FIG. 2 depicts a single in-plane optical waveguide 224 and a single planar guided wave modulator 226 for simplicity, Layer 2 (220) may include one or more in-plane optical waveguides 224, each coupled a corresponding optical coupling device 222. Each in-plane optical waveguide 224 is also coupled to a corresponding planar guided wave modulator 226.

In other embodiments, multiple optical coupling devices 222 may be coupled to a shared in-plane optical waveguide 224 that is in turn coupled to a planar guided wave modulator 226. In another embodiment, Layer 1 (210) includes a single emitter 212, and Layer 2 (220) includes a corresponding single optical coupling device 222, a single in-plane optical waveguide 224 coupled to the optical coupling device 222, and a single planar guided wave modulator 226 coupled to the in-plane optical waveguide 224. Each emitter 212 of Layer 1 (210) is downward-facing and is configured to emit light toward a first surface of Layer 2 (220) in a direction at least primarily orthogonal to the corresponding planar guided wave modulator 226. Specifically, each emitter 212 is optically coupled to its corresponding optical coupling device 222 without an intervening optical fiber.

The emitter 212 may be operated in a continuous wave manner such that the optical data stream is generated by external modulation performed by the planar guided wave modulator 226 rather than by modulating the emitter 212 directly. Each emitter 212 may also be configured to emit broadband light. For example, the emitters 212 may be light-emitting diodes (LEDs) or micro-LEDs, which are intrinsically broadband emitters whose spectral output may span tens of nanometers. In some embodiments, the broadband emitter 212 is an SLD, which combines laser-like brightness and spatial coherence with broad spectral bandwidth, providing higher output power and improved beam collimation relative to a conventional LED while remaining compatible with broadband external modulation by the planar guided wave modulator 226. In some embodiments, the broadband light is produced by a combination of a plurality of narrowband emitters, such as one or more vertical-cavity surface-emitting lasers (VCSELs), whose combined spectral output spans a broadband spectral range. In this scenario, the combination of narrowband emitters forms a broadband emitter 212. The broadband light emitted by the emitters 212 may have a full-width half-maximum (FWHM) spectral width of at least ten nanometers (nm). The optical coupling device 222 may be a grating coupler configured to receive the broadband light incident upon the first surface of Layer 2 (220) and redirect the received light into the planar guided wave modulator 226 via the corresponding in-plane optical waveguide 224.

In Layer 1 (210), multiple emitters 212 that have different light wavelengths may be used. Various multiplexing schemes may also be implemented in the integrated photonics circuit 200. Spatial multiplexing may be implemented using the array of emitters 212 and the corresponding array of optical coupling devices 222 and respective planar guided wave modulators 226. This is implemented without a corresponding bundle of optical fibers. FIG. 2 depicts a generic layered arrangement that is not limited to a specific integration approach. In various embodiments, Layer 1 (210) and Layer 2 (220) may be realized as discrete integrated circuits bonded together, as heterogeneous process layers, or as a monolithically integrated stack, as further described with reference to FIG. 3 and FIG. 4.

FIG. 3 is a perspective view of an integrated photonics circuit 300 in accordance with an embodiment of the present disclosure. The integrated photonics circuit 300 includes a first integrated circuit 310, referred to herein as Chip 1, and a second integrated circuit 320, referred to herein as Chip 2. Chip 1 (310) includes an array of broadband emitters, depicted as emitters 312a, 312b, and 312c, and collectively referred to as emitters 312. Chip 2 (320) includes a corresponding array of optical coupling devices, depicted as optical coupling devices 322a, 322b, and 322c, and collectively referred to as optical coupling devices 322. Chip 2 (320) also includes a plurality of in-plane optical waveguides 324, each coupled to a corresponding one of the optical coupling devices 322, and a corresponding plurality of planar guided wave modulators 326, each coupled to a corresponding one of the in-plane optical waveguides 324.

Although FIG. 3 depicts a single in-plane optical waveguide 324 and a single planar guided wave modulator 326 for simplicity, in an actual implementation each of the optical coupling devices 322 is coupled to a corresponding in-plane optical waveguide 324 and a corresponding planar guided wave modulator 326. The array of emitters 312 and the array of optical coupling devices 322 may be in a 1:1 correspondence such that each optical coupling device 322 a, 322 b, 322c is configured to receive at least a portion of light emitted by a corresponding emitter 312a, 312b, 312c, and each optical coupling device 322 is coupled to a corresponding in-plane optical waveguide 324 and in turn a planar guided wave modulator 326. In an embodiment, each of the optical coupling devices 322 is a grating coupler configured to receive light incident upon a first surface of Chip 2 (320) and redirect the received light into the corresponding in-plane optical waveguide 324.

In an embodiment, Chip 1 (310) and Chip 2 (320) are coupled in a stacked, chip-to-chip arrangement such that the emitters 312 on Chip 1 (310) are downward-facing and positioned to face the first surface of Chip 2 (320), in the same manner described above with reference to FIG. 2. In FIG. 3, each emitter 312 emits broadband light in a direction orthogonal to the planar guided wave modulators 326 and is optically coupled to its corresponding optical coupling device 322 without an intervening optical fiber. The emitters 312 may be operated in a continuous wave manner such that the optical data stream is generated by external modulation performed by the planar guided wave modulators 326. Chip 1 (310) and Chip 2 (320) may be coupled together using any of several integration approaches. For example, Chip 1 (310) may be flip-chipped onto Chip 2 (320), or Chip 2 (320) may be flip-chipped onto Chip 1 (310). In some embodiments, one or more of the emitters 312 may be individually flip-chipped onto Chip 2 (320) in singlets or small groups, up to and including entire arrays, providing flexibility in the granularity of the chip-to-chip integration. In other embodiments, Chip 1 (310) and Chip 2 (320) may be coupled using thermo-compressive hybrid bonding, including die-to-wafer or wafer-to-wafer bonding based on dielectric-to-dielectric and metal-to-metal pad direct bonding. Alternatively, one or both chips may be positioned onto the other using pick-and-place tools, micro-transfer printing, or other transfer-printing methods, as further described with reference to FIG. 4.

In addition to spatial multiplexing described above with reference to FIG. 2, WDM may be implemented in the integrated photonics circuit 300 by configuring a first one of the emitters 312 to emit light having a first wavelength and a second one of the emitters 312 to emit light having a second wavelength different from the first wavelength. In other embodiments, Chip 1 (310) may be implemented as multiple independent chips (e.g., Chip 1a and Chip 1b), each including emitters 312 at different wavelengths, may be attached to Chip 2 (320) to provide multiple WDM channels. For example, Chip 1a includes emitter(s) 312 configured to emit light having a first wavelength, while Chip 1b includes emitter(s) 312 configured to emit light having a second wavelength. Although FIG. 3 depicts three emitters 312 and three optical coupling devices 322 for illustration purposes, the integrated photonics circuit 300 may include any number of emitters and corresponding optical coupling devices, waveguides, and planar guided wave modulators, as indicated by the ellipsis shown in FIG. 3.

In some embodiments, the broadband emitter or array of emitters may be located remotely from the first integrated circuit and optically coupled to the corresponding optical coupling device or devices via one or more optical fibers. Such a fiber-coupled configuration may be appropriate in a range of optical communication environments where physical separation between the emitter and the photonic integrated circuit is required or desirable. For example, in data center interconnects, a broadband emitter module may be mounted on a line card or transceiver cage and connected via optical fiber to a PIC on a separate board or chassis, enabling rack-to-rack or board-to-board optical links over distances of meters to tens of meters. In telecommunications infrastructure, fiber-coupled broadband emitters may serve as optical front-ends for high-density WDM systems, where the emitter module and the modulator PIC are spatially separated within a larger system assembly. In chip-to-chip or chiplet interconnect scenarios where the required optical reach exceeds the practical range of the direct orthogonal coupling approach, an optical fiber may be used to bridge the gap while preserving the broadband external modulation architecture described herein. In all such fiber-coupled embodiments, the optical coupling device on the first integrated circuit receives the broadband light from the optical fiber and redirects it into the in-plane optical waveguide and planar guided wave modulator as described above, and the modulation function remains external to the emitter regardless of the coupling approach used.

In embodiments where an array of broadband emitters is optically coupled to a corresponding array of optical coupling devices via optical fibers, a plurality of optical fibers may be used, with each optical fiber coupling a corresponding one of the broadband emitters to a corresponding one of the optical coupling devices. The array of emitters and the corresponding array of optical fibers and optical coupling devices may be in a 1:1:1 correspondence, such that each emitter is coupled to a dedicated optical fiber and a dedicated optical coupling device, and each optical coupling device is in turn coupled to a dedicated in-plane optical waveguide and planar guided wave modulator. In some embodiments, a fiber ribbon cable or multi-fiber connector assembly may be used to route the plurality of optical fibers between the emitter array and the PIC, enabling high-density array-scale integration while maintaining the spatial correspondence between emitters and modulators. In other embodiments, multiple broadband emitters may share a single optical fiber through WDM, with each emitter operating at a distinct wavelength and the combined broadband output transmitted over a single fiber to a corresponding WDM-capable optical coupling device on the first integrated circuit. These fiber-coupled array embodiments extend the architectures described with reference to FIG. 2 and FIG. 3 to configurations where physical separation between the emitter layer and the photonic integrated circuit layer is bridged by optical fiber rather than by direct orthogonal coupling.

FIG. 4 is a side view of a portion of an integrated photonics circuit 400 illustrating a flip-chip bonding arrangement in accordance with an embodiment of the present disclosure. For example, FIG. 4 depicts one implementation of the chip-to-chip stacked arrangement described above with reference to FIG. 3, showing the layer structure and bonding interface between Chip 1 (310) and Chip 2 (320) in cross-section. The upper portion of FIG. 4 includes a first integrated circuit 402, referred to herein as Chip 1, which includes an emitter 412, which in this embodiment is a vertical-cavity surface-emitting laser (VCSEL). Chip 1 (402) includes an electrode 410, for example a 50 micrometer (μm) gold foil, disposed above the emitter 412 and serves as an electrical contact for driving the emitter 412. Chip 1 (402) also includes dielectric layers 414, for example Benzocyclobutene (BCB) polymer layers, disposed on either side of the emitter 412, which provide electrical isolation between the emitter 412 and the surrounding structure. At the bottom of the Chip 1 (402), bonding interfaces 416, for example gold/titanium (Au/Ti) and microsolder stacks, are disposed on either side of the emitter 412 and form the bonding interface between Chip 1 (402) and a second integrated circuit 404, referred to herein as Chip 2. The bonding interfaces 416 of Chip 1 (402) also serve as electrical contact layers. For example, the microsolder contacts provide the mechanical and electrical interconnect that bonds Chip 1 (402) to Chip 2 (404) upon reflow. This bonding arrangement is an example of the flip-chip bonding approach, in which Chip 1 (402) is flip-chipped onto Chip 2 (404) such that the emitter 412 faces downward toward Chip 2 (404).

In some embodiments, Chip 1 (402) further includes a wavelength conversion material layer (not shown in FIG. 4) disposed on a light-emitting surface of the emitter 412, between the electrical contact layers in the bonding interfaces 416. The wavelength conversion material layer is positioned such that light emitted downward by the emitter 412 passes through the wavelength conversion material layer before reaching the oxide cladding layer 418 of Chip 2 (404) and the optical coupling device 422. Specifically, the wavelength conversion material layer is adjacent to and faces the emitter 412 and extends between Au/Ti contacts in the bonding interfaces 416 on opposite sides. In an embodiment in which the emitter 412 is a VCSEL emitting light in a visible wavelength range of between approximately 380 nm and 500 nm, the wavelength conversion material layer converts the emitted light to a wavelength range of between approximately 1200 nm and 1300 nm prior to coupling into the optical coupling device 422. This wavelength conversion may be desirable in some cases because Chip 2 (404) may be fabricated using silicon-based technology such as CMOS, and silicon exhibits relatively high absorptivity at visible wavelengths. Thus, in such cases it is advantageous to shift the emission into a wavelength range at which silicon is substantially transparent, so that optical coupler and waveguide structures operate with increased efficiency. The wavelength conversion material layer may be deposited on the emitter 412 prior to flip-chip bonding, and is disposed within the Chip 1 (402) layer stack between the emitter 412 and the bonding interfaces 416. Suitable wavelength conversion materials include phosphor-based materials, quantum dot films, and other photoluminescent materials configured to absorb light at the emitter emission wavelength and re-emit at the desired longer wavelength. In other embodiments where the emitter 412 already emits at a wavelength compatible with the silicon photonics platform, a wavelength conversion material layer is not included.

The lower portion of FIG. 4 corresponds to Chip 2 (404) which is a silicon photonics platform comprising multiple layers. Chip 2 (404) includes an oxide cladding layer 418 disposed at the top of Chip 2 (404), immediately below the bonding interfaces 416. The oxide cladding layer 418 serves as an optical coupling layer into which the light emitted by the emitter 412 is directed orthogonally downward. Chip 2 (404) includes an optical coupling device 422 disposed below the oxide cladding layer 418. The optical coupling device 422 forms an in-plane optical path of Chip 2 (404). As indicated by the arrows in FIG. 4, light from the emitter 412 is coupled into the optical coupling device 422 via the oxide cladding layer 418, and then propagates in-plane in both directions along the optical coupling device 422.

The optical coupling device 422 is a grating coupler configured to receive the light incident upon the surface of the oxide cladding layer 418 and redirect the received light into the in-plane optical path of Chip 2 (404) in both directions. The grating coupler resolves the geometric mismatch between the vertically emitted light from the emitter 412 and the horizontally propagating guided mode of the in-plane optical path of Chip 2 (404). The grating coupler is positioned between the bonding interfaces 416 and aligned with the positioning of the emitter 412 to receive the vertically emitted light therefrom. As shown in FIG. 4, the grating coupler is shaped as a periodic pattern of etched ridges or grooves acting as an optical diffractive structure that redirects vertically incident light into a horizontal guided mode of the waveguide provided by the optical coupling device 422 along the in-plane optical path of Chip 2 (404). Chip 2 (404) also includes a buried oxide layer 432 disposed below the optical coupling device 422 and provides optical confinement for the guided waves propagating in the optical coupling device 422. At the bottom of Chip 2 (404), a silicon substrate 434 is disposed below the buried oxide layer 432 and provides mechanical support for the Chip 2 (404) stack.

Chip 2 (404) also includes a silicon waveguide layer 424 and a planar guided wave modulator 426 coupled to the silicon waveguide layer 424 and the optical coupling device 422. Both the silicon waveguide layer 424 and the planar guided wave modulator 426 are disposed on the buried oxide layer 432. The planar guided wave modulator 426 is configured to receive the light redirected by the optical coupling device 422 and guided by the silicon waveguide layer 424. The planar guided wave modulator 426 is configured to modulate the light to produce a modulated optical data stream, which exits Chip 2 (404) as indicated by the modulated light designated arrow in FIG. 4. In this embodiment, the emitter 412 is optically coupled to the optical coupling device 422 without an intervening optical fiber using the flip-chip bonding arrangement that positions the emitter 412 directly above the oxide cladding layer 418 of Chip 2 (404). The planar guided wave modulator 426 may be an electro-optical CHPW as further described below with reference to FIG. 5. Although FIG. 4 depicts a VCSEL as the emitter 412, other emitter types, may be used in place of or in addition to the VCSEL, with appropriate adjustment of the bonding and electrode layers. For example, in some embodiments, the emitter 412 is a broadband emitter that emits broadband light, such as micro-LEDs or LEDs.

In embodiments of the present disclosure, the planar guided wave modulator may be implemented as an electro-optical CHPW. The CHPW exploits a class of electromagnetic waves known as surface plasmon polaritons (SPPs) to achieve the confinement and modulation properties described herein. SPPs are electromagnetic waves that travel along an interface between a metal and a dielectric, resulting from the coupling between collective oscillations of free electrons in the metal and optical electromagnetic modes in the dielectric. SPPs are able to be confined in sub-wavelength dimensions, making them useful for applications in miniaturized photonic devices, optical sensors, and data communications on the nanometer scale. However, using SPPs to design optical devices in sub-wavelength dimensions presents challenges, including inherent propagation losses due to metals. SPP waves, also referred to as plasmonic modes, can suffer energy losses in a relatively short propagation length.

To address these limitations, CHPWs are presented herein to design miniature photonic devices on a sub-micrometer or nanometer scale. CHPWs combine dielectric waveguides with metal-dielectric interfaces to achieve a balance between mode confinement and propagation loss of plasmonic modes. Conventional silicon photonic waveguides confine light through refractive index contrast between the silicon core and surrounding cladding. CHPWs achieve significantly higher mode confinement by incorporating a metal-dielectric interface, reducing device dimensions to scales comparable to electronic components and enabling tighter integration of photonics and electronics on the same platform. CHPWs exhibit broadband spectral tolerance that is not available in conventional narrowband modulators such as carrier-depletion modulators or thermally-tuned ring resonators, making CHPWs well-suited as external modulators for broadband emitters such as micro-LEDs and LEDs.

According to various embodiments of this disclosure, the CHPW is configured to provide an electro-optic effect for manipulating coupled plasmonic modes and modulating the electromagnetic waves of light that propagate in the electro-optical CHPW, also referred to herein as guided waves. The CHPW comprises an electro-optical material layer coupled to an adjustable voltage source. The voltage source can be used to apply a voltage to change optical properties, such as the refractive index, of the electro-optical material based on the electro-optic effect. By controlling the applied voltage, the optical properties of the electro-optical material can be varied to manipulate the coupled plasmonic modes and modulate the guided waves. This voltage-controlled modulation enables the CHPW to function as a high-speed external modulator for broadband light received from the optical coupling device, producing a modulated optical data stream at data rates that are independent of the emitter modulation bandwidth. The design of the CHPW enables enhanced or maximum overlap between the electromagnetic mode and the electro-optical material layer, thereby reducing the voltage required to achieve a given amount of modulation of the electromagnetic field.

FIG. 5 is a cross-sectional view of an electro-optical CHPW 500, which may be referred to more generally as a planar guided wave modulator, in accordance with an embodiment of the present disclosure. The electro-optical CHPW 500 comprises four layers arranged in a stack along the y-direction, as indicated by the coordinate axes shown in FIG. 5. A first semiconductor layer 540 forms the bottom of the stack and serves as one of the cladding layers that contains the propagating guided waves in the thickness direction (y-direction). An electro-optical material layer 530 is disposed on the first semiconductor layer 540 and forms the active modulation region of the CHPW 500. A metal layer 520 is disposed on the electro-optical material layer 530 and is in contact with the electro-optical material layer 530 on respective sides and surfaces thereof. The electro-optical material layer 530 and the metal layer 520 together form the core of the electromagnetic waveguide within which the guided wave propagates along the length of the CHPW 500 in the z-direction. A second semiconductor layer 510 is disposed on the metal layer 520 and forms the top cladding layer. The first semiconductor layer 540 and the second semiconductor layer 510 effectively form claddings that contain the propagating guided waves in the y-direction, and accordingly the refractive index of the electro-optical material layer 530 is less than the respective refractive indices of the first semiconductor layer 540 and the second semiconductor layer 510. A voltage contact V is connected to the metal layer 520 on the left side of the CHPW 500, and a ground contact G is connected to the first semiconductor layer 540 on the right side of the CHPW 500. In another embodiment, the contacts can be reversed such that the voltage contact V is connected to the first semiconductor layer 540 and the ground contact G is connected to the metal layer 520. The respective thicknesses of the electro-optical material layer 530 and the metal layer 520 are less than the width of the CHPW 500 in the x-direction, and in some embodiments are on the order of tens of nanometers. A ratio of the thickness of the metal layer 520 to the wavelength of light in the coupled plasmonic modes is less than 0.1 in some embodiments, meaning the wavelength of the light is at least ten times the thickness of the metal layer 520.

The electro-optical material layer 530 is configured to modulate light in coupled plasmonic modes therein based on a voltage applied across its thickness in the y-direction via the voltage contact V and the ground contact G. The molecules of the electro-optical material are oriented, according to the fabrication process, in a direction that promotes change in the refractive index in response to the applied voltage. As light passes through the electro-optical material layer 530, it undergoes a phase shift in response to the change in refractive index, enabling modulation based on the applied voltage. In some embodiments, the electro-optic effect is a linear electro-optic effect, also referred to as the Pockels effect, in which the applied electric field induces a linear change in the refractive index proportional to the strength of the electric field. In other embodiments, the electro-optic effect is a quadratic electro-optic effect, also referred to as the Kerr effect, in which the refractive index changes at a faster rate in response to the applied field, enabling higher modulation speeds suitable for demanding high-speed optical communication applications. In some embodiments, the electro-optical material of the electro-optical material layer 530 comprises LiNbO3. In some embodiments, at least one of the first semiconductor layer 540 and the second semiconductor layer 510 comprises Si or doped SiO2. In other embodiments, the electro-optical material may comprise crystalline silicon, indium phosphide, or other electro-optical materials, including optical crystals, polymers, dielectrics, organic materials, nanocomposite materials, or metamaterials. In some embodiments, the electro-optical material layer 530 comprises a semiconductor material configured with quantum dots to produce the electro-optic effect. The layers of the CHPW 500 can be formed using semiconductor chip processing and fabrication technologies, such as CMOS, or other suitable fabrication processes, enabling integration of the CHPW 500 with conventional electronic circuits on the same platform.

The CHPW 500 illustrated in FIG. 5 can correspond to the planar guided wave modulator referenced throughout FIGS. 1-4. In an embodiment, in FIG. 1, the CHPW 500 is the modulator 126 inside Chip 2 (120). In FIG. 2 and FIG. 3, the CHPW 500 may be any of the planar guided wave modulators 226 and 326, respectively, each coupled to a corresponding in-plane optical waveguide and optical coupling device in Layer 2 or Chip 2 (320). In FIG. 4, the CHPW 500 may be the planar guided wave modulator 426 coupled to the optical coupling device 422 through the silicon waveguide layer 424.

In some embodiments, the electro-optical material layer 530 of the CHPW 500 is edge coupled to the in-plane optical waveguide that routes light from the optical coupling device to the planar guided wave modulator. In edge coupling, the guided light propagating in the in-plane optical waveguide is coupled directly into the end facet of the CHPW 500, entering the electro-optical material layer 530 laterally along the z-direction rather than from above. Edge coupling is well-suited to the CHPW architecture because the optical mode of the in-plane waveguide and the guided mode of the CHPW 500 propagate in the same z-direction, allowing efficient mode overlap and coupling at the interface between the waveguide and the CHPW 500. The dimensions of the in-plane optical waveguide and the CHPW 500 may be configured to maximize this mode overlap and minimize coupling losses at the edge interface.

In some embodiments, the electro-optical CHPW described herein may be incorporated into a transceiver device. The transceiver device may include a light source optically coupled to the electro-optical CHPW, wherein the electro-optical CHPW serves as a transmitter modulator configured to modulate light from the light source. The transceiver device may also include a photodetector optically coupled to the electro-optical CHPW, and a control circuit electrically coupled to the electro-optical CHPW and configured to control a voltage applied across the thickness of the electro-optical material layer to perform the modulation. In some embodiments, the transceiver device includes a plurality of photodetectors, wherein the electro-optical CHPW is optically coupled to one or more optical paths leading to the respective photodetectors via corresponding waveguides or optical fibers. In other embodiments, the transceiver device includes a plurality of light sources, wherein the electro-optical CHPW is optically coupled to one or more optical paths of the respective light sources via corresponding waveguides or optical fibers. In further embodiments, the transceiver device includes a plurality of photodetectors and respective light sources, wherein the electro-optical CHPW is optically coupled to one or more optical paths of both the photodetectors and the light sources via corresponding waveguides or optical fibers. The transceiver device may be integrated onto a platform compatible with conventional electronic technologies, such as a circuit board or a chip, enabling the construction of high-density opto-electronic systems for a wide range of data communications applications.

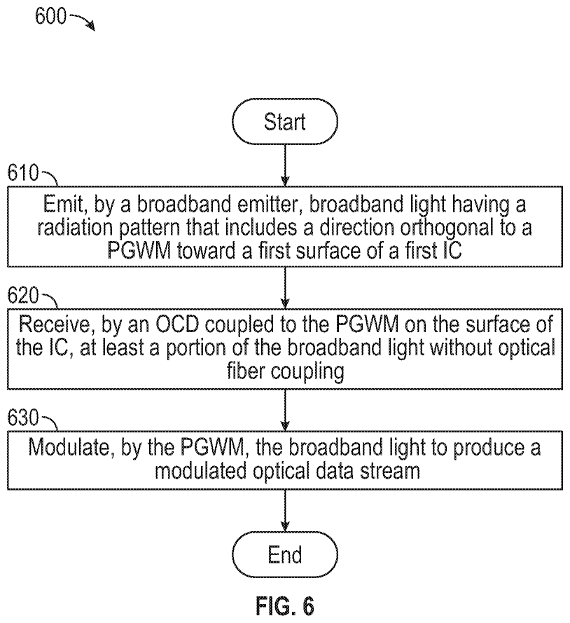

FIG. 6 is a flowchart of a method 600 of externally modulating broadband light in an integrated photonics circuit in accordance with an embodiment of the present disclosure. The method 600 corresponds to the integrated photonics circuit architectures described above with reference to FIGS. 1-5, and in particular to the operation of the broadband emitter, optical coupling device, and planar guided wave modulator in those embodiments. The method 600 begins at step 610 by emitting, by a broadband emitter, broadband light having a radiation pattern that includes a direction orthogonal to a planar guided wave modulator (PGWM) toward a first surface of a first integrated circuit (IC). In an embodiment, the broadband emitter of step 610 is a micro-LED, a VCSEL, or a combination of narrowband emitters whose combined spectral output spans a broadband spectral range, as described above with reference to FIGS. 2 and 3. The broadband emitter is operated in a continuous wave manner such that the light emitted in step 610 is unmodulated. The optical data stream is generated by the external modulation performed in step 630, rather than by modulating the emitter itself.

The method 600 continues at step 620 by receiving, by an optical coupling device (OCD) coupled to the PGWM on the first surface of the IC, at least a portion of the broadband light without optical fiber coupling. The optical coupling device receives the orthogonally incident broadband light and redirects it into an in-plane optical waveguide, as described above with reference to FIGS. 1-4. In an embodiment, the optical coupling device is a grating coupler configured to resolve the geometric mismatch between the vertically emitted broadband light and the horizontally propagating guided mode of the in-plane waveguide by acting as a diffractive structure that redirects vertically incident light into the horizontal guided mode of the waveguide, such that one of the diffracted orders couples efficiently into the waveguide mode propagating along the chip surface.

The method 600 continues at step 630 by modulating, by the PGWM, the broadband light to produce a modulated optical data stream. The PGWM receives the broadband light routed in-plane from the optical coupling device via the waveguide and externally modulates it to encode a data stream onto the light, producing a modulated optical data stream at a data rate independent of the modulation bandwidth of the emitter. In an embodiment, modulating the broadband light can be achieved applying a voltage across an electro-optical material layer of a CHPW to create coupled plasmonic modes within the electro-optical material layer, thereby modulating the broadband light via an electro-optic effect that changes a refractive index of the electro-optical material layer in proportion to the applied voltage. This electro-optic modulation corresponds to the CHPW 500 described above with reference to FIG. 5, in which the voltage applied between contact V and contact G across the electro-optical material layer 530 produces the refractive index change that phase-modulates the coupled plasmonic modes propagating in the z-direction. The modulated optical data stream in step 630 exits the first IC as the output of the integrated photonics circuit, as depicted by the modulated light output arrows in FIGS. 1-4. The method 600 is not limited to any particular integration approach between the broadband emitter and the first integrated circuit. The emitter may be disposed on a second integrated circuit bonded to the first integrated circuit in a chip-to-chip arrangement as described with reference to FIG. 3 and FIG. 4, or may be part of a layered or monolithic arrangement as described with reference to FIG. 2.

One of ordinary skill in the art will appreciate that the integrated photonics circuit architectures described herein may be used as part of a larger device, including but not limited to a photonic fabric within an interposer. Such an interposer supports very high-speed optical interconnects from chiplet to chiplet, such as accelerated processing units (XPUs), high-bandwidth memory (HBM), and other types of processing and memory devices attached to one surface of the interposer. By replacing electrical interconnects with optical ones, such an interposer alleviates the inherent tradeoff between power consumption, reach, and bandwidth that constrains conventional electrical interconnect approaches, enabling higher bandwidth over longer distances without a corresponding increase in power dissipation. An array of externally-modulated broadband emitters as described herein can support a high bandwidth optical reach of on the order of 10 meters (m). When this reach falls short of the required system reach, an array of externally-modulated VCSELs may be used in place of micro-LEDs, providing a higher-power, longer-reach alternative while preserving the external modulation architecture and the no-fiber coupling approach described herein. In these and other configurations, the embodiments described herein provide a scalable optical interconnect fabric that decouples modulation speed from emitter physics and eliminates the fiber bundle packaging constraints of conventional approaches.

As used within the written disclosure and in the claims, the terms “including” and “comprising” (and inflections thereof) are used in an open-ended fashion, and thus should be interpreted to mean “including, but not limited to.” Unless otherwise indicated, as used throughout this document, “or” does not require mutual exclusivity, and the singular forms “a,” “an,” and “the” are intended to include the plural forms as well, unless the context clearly indicates otherwise.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component via another component or directly connected to the second component.

As used herein, the term “plurality” denotes two or more. For example, a plurality of components indicates two or more components.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or implementations.

As used herein, the term “and/or” encompasses any combination of listed elements. For example, “A, B, and/or C” includes the following sets of elements: A only, B only, C only, A and B without C, A and C without B, B and C without A, and a combination of all three elements, A, B, and C.

The descriptions of the various embodiments of the present invention have been presented for purposes of illustration, but are not intended to be exhaustive or limited to the embodiments disclosed. The description of the disclosed embodiments is provided to enable any person skilled in the art to make or use the present invention. The terminology used herein was chosen to best explain the principles of the embodiments, the practical application or technical improvement over technologies found in the marketplace, or to enable others of ordinary skill in the art to understand the embodiments disclosed herein. Many modifications and variations will be apparent to those of ordinary skill in the art without departing from the scope and spirit of the described embodiments. For example, it will be appreciated that one of ordinary skill in the art will be able to employ a number corresponding alternative and equivalent structural details. Thus, the present invention is not intended to be limited to the embodiments shown herein but is to be accorded the widest scope consistent with the principles and novel features disclosed herein.

What is claimed is:

1. An integrated photonics circuit, comprising:
an optical coupling device configured to receive light incident upon a first surface of the optical coupling device;
a planar guided wave modulator coupled to the optical coupling device and configured to receive and externally modulate light from the optical coupling device; and
a broadband emitter configured to emit broadband light having a radiation pattern that includes a direction orthogonal to the planar guided wave modulator toward the first surface of the optical coupling device,
wherein the optical coupling device is configured to receive at least a portion of the broadband light emitted by the broadband emitter.

2. The integrated photonics circuit of claim 1, wherein the broadband emitter faces the first surface of the optical coupling device and is configured to emit the broadband light vertically toward the optical coupling device.

3. The integrated photonics circuit of claim 1, wherein the broadband emitter is optically coupled to the optical coupling device without an optical fiber.

4. The integrated photonics circuit of claim 1, wherein the broadband emitter comprises a light-emitting diode (LED), a micro-LED, or a superluminescent diode (SLD).

5. The integrated photonics circuit of claim 1, wherein the broadband light emitted by the broadband emitter has a full-width half-maximum (FWHM) spectral width of at least ten nanometers (nm).

6. The integrated photonics circuit of claim 1, wherein broadband emitter comprises a combination of a plurality of narrowband emitters whose combined spectral output spans a broadband spectral range.

7. The integrated photonics circuit of claim 1, wherein the broadband emitter is configured to operate in a continuous wave manner, and wherein the planar guided wave modulator is configured to externally modulate the broadband light to generate a modulated optical data stream.

8. The integrated photonics circuit of claim 1, further comprising an in-plane optical waveguide coupled to the planar guided wave modulator, wherein the optical coupling device comprises a grating coupler configured to:
receive light incident orthogonally to the planar guided wave modulator; and
redirect the received light into the in-plane optical waveguide.

9. The integrated photonics circuit of claim 1, wherein the planar guided wave modulator comprises an electro-optical coupled hybrid plasmonic waveguide (CHPW), the CHPW comprising:
an electro-optical material layer configured to modulate light in coupled plasmonic modes therein;
a first semiconductor layer adjacent to a first surface of the electro-optical material layer; and
a metal layer adjacent to a second surface of the electro-optical material layer,
wherein the electro-optical material layer is configured to modulate the broadband light in the coupled plasmonic modes based on a voltage applied across a thickness of the electro-optical material layer.

10. The integrated photonics circuit of claim 9, wherein the electro-optical material layer comprises lithium niobate (LiNbO3), and wherein at least one of the first semiconductor layer and a second semiconductor layer of the CHPW comprises silicon (Si) or doped silicon oxide (SiO2).

11. An integrated photonics circuit, comprising:
a first integrated circuit, comprising:
one or more optical coupling devices configured to receive light incident upon a first surface of the first integrated circuit; and
one or more planar guided wave modulators, each coupled to a corresponding optical coupling device and configured to receive and externally modulate light from the corresponding optical coupling device; and
a second integrated circuit, comprising one or more emitters configured to emit light toward the first surface of the first integrated circuit,
wherein the light has a radiation pattern that includes a direction orthogonal to the one or more planar guided wave modulators, and
wherein the first integrated circuit is coupled to the second integrated circuit in a stacked, chip-to-chip manner.

12. The integrated photonics circuit of claim 11, wherein the one or more emitters comprise one or more vertical-cavity surface-emitting lasers (VCSELs).

13. The integrated photonics circuit of claim 11, wherein the one or more emitters and the one or more optical coupling devices are in a 1:1 correspondence such that each optical coupling device is configured to receive at least a portion of light emitted by a corresponding emitter.

14. The integrated photonics circuit of claim 11, wherein each emitter is optically coupled to a corresponding optical coupling device without an optical fiber.

15. The integrated photonics circuit of claim 11, wherein the first integrated circuit is flip-chipped onto the second integrated circuit, or wherein the second integrated circuit is flip-chipped onto the first integrated circuit.

16. The integrated photonics circuit of claim 11, wherein the first integrated circuit and the second integrated circuit are coupled using thermo-compressive hybrid bonding, including die-to-wafer bonding or wafer-to-wafer bonding, based on dielectric-to-dielectric and metal-to-metal pad direct bonding.

17. The integrated photonics circuit of claim 11, wherein the first integrated circuit is coupled to the second integrated circuit using pick-and-place tools, micro-transfer printing, or other transfer-printing methods, or wherein the second integrated circuit is coupled to the first integrated circuit using pick-and-place tools, micro-transfer printing, or other transfer-printing methods.

18. The integrated photonics circuit of claim 11, wherein the second integrated circuit comprises an array of emitters, wherein a first one of the array of emitters is configured to emit light having a first wavelength, wherein a second one of the array of emitters is configured to emit light having a second wavelength different from the first wavelength, and wherein the integrated photonics circuit is configured to implement a wavelength division multiplexing (WDM) scheme using the first emitter and the second emitter.

19. A method of externally modulating broadband light in an integrated photonics circuit, the method comprising:
emitting, by a broadband emitter, broadband light having a radiation pattern that includes a direction orthogonal to a planar guided wave modulator toward a first surface of a first integrated circuit;
receiving, by an optical coupling device coupled to the planar guided wave modulator on the first surface of the first integrated circuit, at least a portion of the broadband light from the broadband emitter without optical fiber coupling; and
modulating, by the planar guided wave modulator, the broadband light to produce a modulated optical data stream.

20. The method of claim 19, wherein the modulating comprises applying a voltage across an electro-optical material layer of a coupled hybrid plasmonic waveguide (CHPW) to create coupled plasmonic modes within the electro-optical material layer, thereby modulating the broadband light via an electro-optic effect that changes a refractive index of the electro-optical material layer in proportion to the applied voltage.
